(19) United States
(12) Patent Application Publication
(10) Pub. No.: US 2006/0036490 A1
(43) Pub. Date: Feb. 16, 2006

(54) Methods and apparatus for marketing community-oriented advertising opportunities

(76) Inventor: Michelle Sagalyn, Southport, CT (US)

Correspondence Address: Steven M. Santisi, 80 Lounsbury Ln, Ridgefield, CT, 06877, US

(21) Appl. No.: 11/205,244

(22) Filed: Aug. 15, 2005

Related U.S. Application Data
(60) Provisional application No. 60/601,265, filed on Aug. 13, 2004.

(51) Int. Cl. G06Q 30/00

(52) U.S. Cl. 705/14

(57) ABSTRACT

The present invention includes compiling a database listing a plurality of future events, each future event to be sponsored by one or more non-profit institutions and having at least one associated advertising opportunity and an associated participation fee. The participation fee may be determined by an advertising opportunities aggregator, the institutions, and/or a market place. The aggregator identifies or otherwise notifies a plurality of advertisers and offers at least one of the advertisers an option to participate in the advertising opportunities in exchange for the participation fee. The participation fee may include a contribution portion for the non-profit institution sponsoring the future event and an advertising fee portion for the advertising opportunity aggregator. The present invention may also be embodied as a system, including a network, software, and databases, for automating the above method.

### CROSS-REFERENCE TO RELATED APPLICATION

The present invention claims priority to U.S. Provisional Patent Application No. 60/601,265 filed Aug. 13, 2004, entitled “Methods And Apparatus For Marketing Community-Oriented Advertising Opportunities” which is hereby incorporated herein by reference in its entirety for all purposes.

### FIELD OF THE INVENTION

The present invention relates generally to marketing and advertising, and more specifically, to methods and apparatus for brokering advertising opportunities associated with institution fund raising events.

### BACKGROUND

Existing advertising methods are often ineffective as customer acquisition tools. Advertising using mass media is expensive, unfocused, and not usually effective for the vast majority of businesses that serve specific geographic areas or communities. In such advertising, the advertising message is broadcast, along with many competing messages, to large geographic areas in the hopes that a small target group will receive the information and not ignore it. Such advertisements are so pervasive that they are frequently ignored.

Effectively advertising in community publications such as school graduation programs, charity tournament fundraising booster books, and high school theater playbills, is often difficult for business for a number of reasons. Such publications are typically produced at irregular intervals by different, inexperienced volunteers who are not familiar with standard advertising customs and practices

Private schools, other non-profit community organizations, and other institutions frequently rely upon ad hoc fundraising activities to finance many events and even parts of their operating budgets. The fundraising related publications produced by such organizations typically include only limited advertising opportunities which the organizations attempt to sell in isolation for an amount unrelated to the value of the advertising opportunities. Typically, the non-professional volunteers who try to sell the advertising opportunities are merely hoping to raise enough money to fund the particular single publication or a part of an associated event. The sales and advertising processes are not systematized and vary from year to year based upon the volunteers' inconsistent level of commitment and inexperience. Potential advertisers are typically unable to cost justify spending unbudgeted funds on such inconsistent, untargeted, “one-off” advertising opportunities and typically regard such opportunities as not being commercially viable or interesting.

What is needed are systems and methods to make advertising opportunities associated with an institution and/or its fundraising events that individually may not be commercially significant, into commercially viable advertising opportunities.

### SUMMARY OF THE INVENTION

The present invention overcomes the above and other drawbacks of the prior art by offering systems and methods for aggregating and marketing institution based advertising opportunities related to fundraising events. In some embodiments of the present invention, a market for buying and selling valuable but previously unmarketable advertising opportunities is formed. Advertisers are provided with structured and competitively priced opportunities to both purchase valuable targeted advertising and develop goodwill by investing in a community through participation in the community's institutions' fundraising events.

According to some embodiments of the present invention, an adverting opportunities aggregator compiles a database listing a plurality of future events, each future event to be sponsored by one or more non-profit institutions and having at least one associated advertising opportunity and an associated participation fee. The participation fee may be determined by the aggregator, the institutions, and/or a market place. The aggregator identifies or otherwise notifies a plurality of advertisers and offers at least one of the advertisers an option to participate in the advertising opportunities in exchange for the participation fee. In some embodiments, the participation fee includes a contribution portion for the non-profit institution sponsoring the future event and an advertising fee portion for the advertising opportunity aggregator. According to some embodiments of the present invention, a system, including a network, software, and databases, for automating the above method is provided.

With these and other advantages and features of the invention that will become hereinafter apparent, the nature of the invention may be more clearly understood by reference to the following detailed description of the invention, to the appended claims and to the several accompanying drawings attached hereto.

### BRIEF DESCRIPTION OF THE DRAWINGS

FIG. 1 is a block diagram illustrating an example of a system according to some embodiments of the present invention.

FIG. 2 is a block diagram illustrating an example of an alternative system according to some embodiments of the present invention.

FIG. 3 is a block diagram illustrating an example of a processor as depicted in FIGS. 1 and 2 according to some embodiments of the present invention.

FIG. 4 is a table illustrating an example data structure of an example advertising opportunities database as depicted in FIG. 3 for use in some embodiments of the present invention.

FIG. 5 is a table illustrating an example data structure of an example advertising packages database as depicted in FIG. 3 for use in some embodiments of the present invention.

FIG. 6 is a table illustrating an example data structure of an example institutions database as depicted in FIG. 3 for use in some embodiments of the present invention.

FIG. 7 is a table illustrating an example data structure of an example advertisers database as depicted in FIG. 3 for use in some embodiments of the present invention.

FIG. 8 is a flow diagram illustrating a first exemplary process according to and for use in some embodiments of the present invention.

FIG. 9 is a flow diagram illustrating a second exemplary process according to and for use in some embodiments of the present invention.

FIG. 10 is a flow diagram illustrating a third exemplary process according to and for use in some embodiments of the present invention.

### DETAILED DESCRIPTION

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that structural, logical, hardware, software, mechanical, and electrical changes may be made without departing from the scope of the present invention. The following description is, therefore, not to be taken in a limited sense, and the scope of the present invention is defined by the appended claims. Note that although most components or elements are referenced using a reference numeral whose most significant digit (or digits) correspond to the figure number within which they appear, components or elements appearing in more than one figure are referenced using the reference numeral with which they were first identified.

The present inventor has recognized that a need exists for systems and methods that help certain institutions, such as private schools, that may not be particularly commercially oriented, receive compensation commensurate with the value they are able to offer in terms of advertising opportunities. At the same time, the present inventor's systems and methods provide commercial entities, such as local merchants, with access to a previously unavailable market of precise and persistent advertising opportunities within the exact communities and demographics such merchants most desire.

A. Terms

Throughout the description that follows and unless otherwise specified, the following terms may include and/or encompass the example meanings provided in this section. These terms and illustrative example meanings are provided to clarify the language selected to describe embodiments of the invention both in the specification and in the appended claims.

The terms “institution” and “user” shall be synonymous and may refer to any person or entity that offers or provides one or more advertising opportunities and/or operates a user device to offer advertising opportunities. Institutions may include non-profit institutions such as some private schools. Institutions may include for-profit institutions, non-commercial institutions, and other organizations. Institutions may include groups, employees, members, students, or any other person within and/or affiliated with an institution.

The term “advertising opportunity” may refer to any place, time, item, publication, event, and/or gathering under the control of one or more institutions wherein an advertisement may be presented and/or displayed.

The term “advertising opportunities aggregator” may refer to any entity that engages in creating a network of institutions willing to contribute advertising opportunities, that individually may be unmarketable, to an advertising opportunities market such that the aggregation of the advertising opportunities together becomes marketable. In some embodiments, the aggregation of advertising opportunities may become marketable as the result of a synergistic effect of the network and/or aggregation of opportunities. In some embodiments, the aggregation may become marketable as the result of the aggregated opportunities' quantity (e.g. exposure, circulation, etc.) and/or value collectively exceeding a threshold required to create a commercially viable advertising product that is worth the consideration of large advertisers.

The term “advertiser” may refer to any entity that may offer, be offered an opportunity, request, and/or negotiate to purchase one or more advertising opportunities. Advertisers may include potential advertisers who may be identified to be solicited or to be excluded from being solicited. Advertisers may include merchants or non-commercial entities or individuals.

The term “advertisement” may refer to any message (including a non-commercial message), display, promotion, demonstration, document, web page, publication, information, and/or sample provided by an advertiser to be used in association with an advertising opportunity.

The terms “products,” “goods,” “merchandise,” and “services” shall be synonymous and may refer to anything licensed, leased, sold, available for sale, available for lease, available for licensing, and/or offered or presented for sale, lease, or licensing including packages of products, subscriptions to products, contracts, information, services, and intangibles.

The term “merchant” may refer to an entity who may offer to sell, lease, and/or license one or more products to a consumer (for the consumer or on behalf of another) or to other merchants. For example, merchants may include sales channels, individuals, agents, companies, manufacturers, distributors, direct sellers, re-sellers, and/or retailers. Merchants may transact out of buildings including stores, outlets, malls, and warehouses, and/or they may transact via any number of additional methods including mail order catalogs, vending machines, online web sites, and/or via telephone marketing. Note that a producer or manufacturer may choose not to sell to customers directly and in such a case, a retailer may serve as the manufacturer's or producer's sales channel.

The terms “server” and “controller” shall be synonymous and may refer to any device that may communicate with one or more operator terminals, one or more third-party servers, one or more user devices, one or more advertiser devices, and/or other network nodes, and may be capable of relaying communications to and from each. Servers may include facilities to support secure communications using encryption or the like. In some embodiments, advertising opportunities aggregators may employ one or more controllers to automate or partially automate the aggregation of advertising opportunities into a market and/or a advertising opportunities package.

The terms “operator terminal” and “remote controller” shall be synonymous and may refer to any device that may communicate with one or more servers, one or more user devices, one or more advertiser devices, one or more third-party service provider servers, and/or other network nodes. In some embodiments, operator terminals may, for example, include personal computers, laptop computers, handheld computers, telephones, kiosks, personal digital assistants, point-of-sale terminals, point of display terminals, cellular phones, automated teller machines (ATMs), pagers, game consoles, vending machines, and/or combinations of such devices. They may include facilities to support secure communications using encryption or the like.

The term “user device” may refer to any device owned or used by users or institutions capable of accessing and/or displaying online and/or offline content. User devices may communicate with one or more servers, one or more advertiser devices, one or more third-party service provider servers, one or more operator terminals, and/or other network nodes. In some embodiments, user devices may, for example, include personal computers, laptop computers, handheld computers, telephones, kiosks, personal digital assistants, point-of-sale terminals, point of display terminals, cellular phones, automated teller machines (ATMs), pagers, game consoles, vending machines, and/or combinations of such devices. User devices may include facilities to support secure communications using encryption or the like.

The terms “merchant device” and “advertiser device” shall be synonymous and may refer to a device that may be capable of receiving instructions from an advertiser and of communicating instructions to a server or controller. The instructions may indicate products to sell, pricing information, benefits, offers, promotions, non-commercial messages, and advertisements. In some embodiments, advertiser devices may, for example, include personal computers, laptop computers, handheld computers, telephones, kiosks, personal digital assistants, point-of-sale terminals, point of display terminals, cellular phones, automated teller machines (ATMs), pagers, game consoles, vending machines, and/or combinations of such devices. User devices may include facilities to support secure communications using encryption or the like.

The term “input device” may refer to a device that is used to receive an input. An input device may communicate with or be part of another device such as a point of sale terminal, a point of display terminal, a user device, a server (e.g., a pressure sensor in a keyboard of a computer), an operator terminal, a controller, etc. Some examples of input devices include: a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, and a weight scale.

The term “output device” may refer to a device that is used to output information. An output device may communicate with or be part of another device (e.g., a user device, a point of sale terminal, a point of display terminal, a controller, etc.). Some examples of output devices include: a cathode ray tube (CRT) monitor, liquid crystal display (LCD) screen, light emitting diode (LED) screen, a printer, an audio speaker, an infra-red transmitter, a radio transmitter.

The terms “I/O device” and “input/output device” shall be synonymous and may refer to any combination of input and/or output devices.

B. System

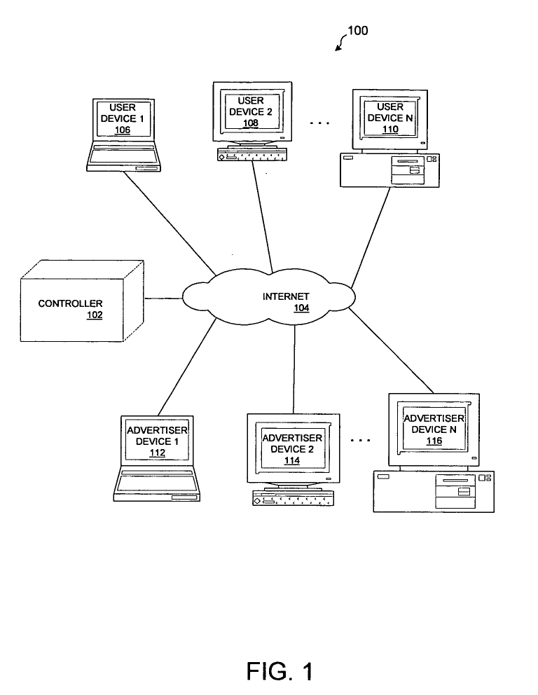

Referring now to FIG. 1, a system 100 according to some embodiments of the present invention includes a controller 102 that is in one or two-way communication via the Internet 104 (or other communications link) with one or more user devices 106, 108, 110, and/or advertiser devices 112, 114, 116. In operation, the controller 102 may function under the control of a merchant or other entity that may also control or own the user devices 106, 108, 110. For example, the controller 102 may be a server in a bank's ATM network, a server in a community's schools or government infrastructure, and/or a server in a merchant's vending machine network. In some embodiments, the controller and the user devices may be one and the same.

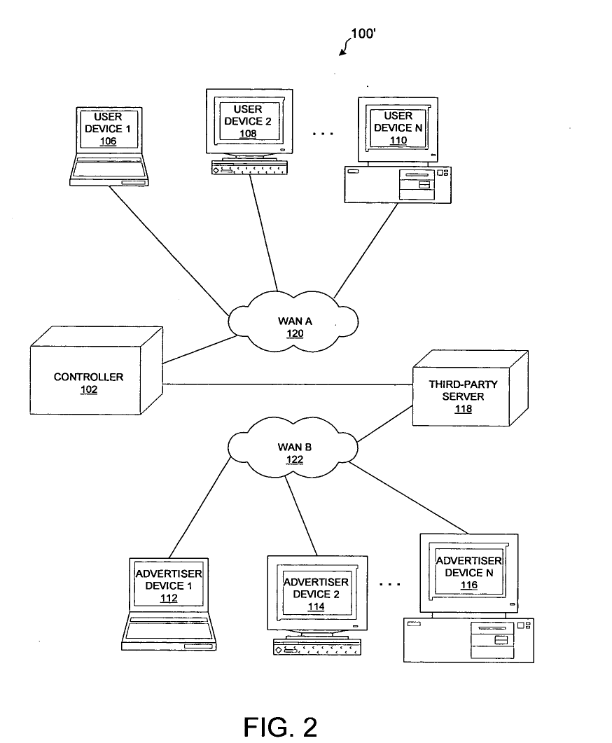

Referring to FIG. 2, an alternative system 100′ according to some embodiments of the present invention further includes one or more third-party service provider servers 118. A third-party service provider server 118, or third-party server 118, may also be in one or two-way communication with the controller 102. However, as shown in the embodiment depicted in FIG. 2, the third-party server 118 may be disposed between the controller 102 and the user devices 106, 108, 110 or advertiser devices 112, 114, 116.

The primary difference between the two alternative embodiments depicted in FIGS. 1 and 2 is that the embodiment of FIG. 2 includes the third-party server 118 which may be operable by an entity both distinct and physically remote from the entity operating the controller 102. The third-party server 118 may perform the methods of the present invention by sending/receiving signals to/from the controller 102 to be relayed to/from the user devices 106, 108, 110 and/or advertiser devices 112, 114, 116. For example, a printing company may operate a third-party server 118 that communicates with a advertising market server (functioning as a controller 102) to receive a collection of advertisements for a publication from a private school personal computer (functioning as a user device 106). In some embodiments such as those depicted in FIG. 1, the functions of the third-party server 118 may be consolidated into the controller 102.

An additional difference between these two example embodiments relates to the physical topology of the systems 100, 100′. In both embodiments, each node may securely communicate with every other node in the systems 100, 100′ via, for example, a virtual private network (VPN). Thus, all nodes may be logically connected. However, the embodiment depicted in FIG. 2 allows the controller 102 and/or the third-party server 118 to serve as a single gateway between the nodes that will typically be operated by the owners of the user devices 106, 108, 110 (and the owner's students, employees, and/or volunteers) and the other nodes in the system 100′, i.e. nodes that may be operated by merchants or others. Thus, in the case that either or both WAN A 120 and WAN B 122 are private networks (e.g. a private LAN and/or WAN not part of the Internet), the user devices 106, 108, 110 and the advertiser devices 112, 114, 116 are physically segmented and can easily be physically separated for security, control, and/or other reasons. In some embodiments, WAN A 120 may be implemented using the Internet while WAN B 122 remains a private LAN or WAN. In some embodiments, WAN B 122 may be implemented using the Internet while WAN A 120 remains a private LAN or WAN. If both WAN A 120 and WAN B 122 are implemented using the Internet, the system 100′ is effectively the same as system 100 with an added direct connection from the controller 102 to a third-party server 118.

In some embodiments, the advertiser devices 112, 114, 116 may each be controlled by different merchants or advertisers. The controller 102 may be operated by an entity that uses the present invention to, for example, deliver different merchants or advertisers to the different users. If there is a third-party server 118, it may be operated by an unrelated entity that merely permits the operators of the controller 102 to have access to different services such as printers, website producers, and promoters. Thus, in such an example embodiment, the system of the present invention may involve merchants (operating advertiser devices 112, 114, 116), an advertising opportunity acquisition and aggregation service agent (operating the controller 102), a website developer and printer (operating third-party servers 118), and institutions (operating user devices 106, 108, 110). In alternative embodiments, an advertiser merchant may operate a combined controller/user device directly and the system may only involve an advertiser and an institution.

In both embodiments pictured in FIGS. 1 and 2, communication between the controller 102 and the advertiser devices 112, 114, 116, the user devices 106, 108, 110, and/or the third-party server 118, may be direct and/or via a network such as the Internet 104.

Referring to both FIGS. 1 and 2, each of the controller 102, the third-party server 118, the advertiser devices 112, 114, 116, and the user devices 106, 108, 110 may comprise computers, such as those based on the Intel® Pentium® processor, that are adapted to communicate with each other. Any number of third-party servers 118, advertiser devices 112, 114, 116, and/or user devices 106, 108, 110 may be in communication with the controller 102. In addition, the user devices 106, 108, 110 may be in one or two-way communication with the advertiser devices 112, 114, 116. The controller 102, the third-party server 118, the advertiser devices 112, 114, 116, and the user devices 106, 108, 110 may each be physically proximate to each other or geographically remote from each other. The controller 102, the third-party server 118, the advertiser devices 112, 114, 116, and the user devices 106, 108, 110 may each include input devices (not pictured) and output devices (not pictured).

As indicated above, communication between the controller 102, the third-party server 118, the advertiser devices 112, 114, 116, and the user devices 106, 108, 110 may be direct or indirect, such as over an Internet Protocol (IP) network such as the Internet 104, an intranet, or an extranet through a web site maintained by the controller 102 (and/or the third-party server 118) on a remote server or over an on-line data network including commercial on-line service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet 104 may not transmit data to the other device for weeks at a time.

The controller 102 (and/or the third-party server 118) may function as a “web server” that presents and/or generates web pages which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A web server allows communication with the controller 102 in a manner known in the art. The advertiser devices 112, 114, 116 and the user devices 106, 108, 110 may use a web browser, such as NAVIGATOR® published by NETSCAPE® for accessing HTML forms generated or maintained by or on behalf of the controller 102 and/or the third-party server 118.

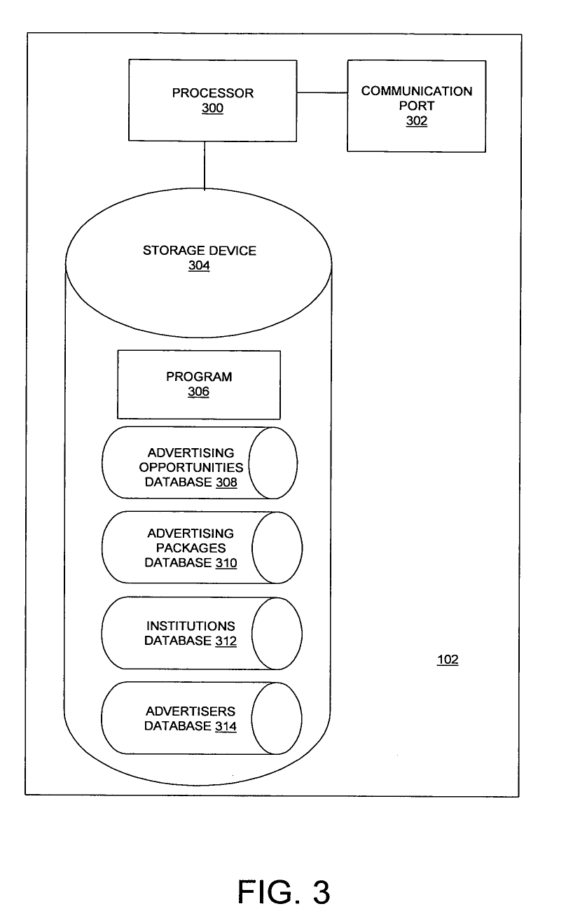

As indicated above, any or all of the controller 102, the third-party server 118, the advertiser devices 112, 114, 116 and the user devices 106, 108, 110 may include, e.g., processor based cash registers, telephones, interactive voice response (IVR) systems such as the ML400-IVR designed by MISSING LINK INTERACTIVE VOICE RESPONSE SYSTEMS, cellular/wireless phones, vending machines, pagers, personal computers, portable types of computers, such as a laptop computer, a wearable computer, a palm-top computer, a hand-held computer, and/or a Personal Digital Assistant (“PDA”). Further details of the controller 102, and/or the third-party server 118, are provided below with respect to FIG. 3.

As indicated above, in some embodiments of the invention the controller 102 (and/or the third-party server 118) may include advertiser devices 112, 114, 116, and/or user devices 106, 108, 110. Further, the controller 102 may communicate with advertisers directly instead of through the advertiser devices 112, 114, 116. Likewise, the controller 102 may communicate with institutions directly instead of through the user devices 106, 108, 110. Although not pictured, the controller 102, the third-party server 118, the advertiser devices 112, 114, 116, and the user devices 106, 108, 110 may also be in communication with one or more user and/or advertiser credit institutions to effect transactions and may do so directly or via a secure financial network such as the Fedwire network maintained by the United States Federal Reserve System, the Automated Clearing House (hereinafter “ACH”) Network, the Clearing House Interbank Payments System (hereinafter “CHIPS”), or the like.

In operation, the advertiser devices 112, 114, 116 and/or the user devices 106, 108, 110 may exchange information about the advertisements, advertising opportunities and any associated events via the controller 102. In embodiments with a third-party server 118, the advertiser devices 112, 114, 116 and/or the user devices 106, 108, 110 may exchange information about the advertisements, advertising opportunities and any associated events via the third-party server 118. The advertiser devices 112, 114, 116 may for example, provide advertisements, promotional information, non-commercial messages, and/or other information to the controller 102 (and/or the third-party server 118). The user devices 106, 108, 110 may provide advertising opportunity, event, and/or other information to the controller 102 (and/or the third-party server 118). The controller 102 (and/or the third-party server 118) may provide information about advertising opportunity rates to the advertiser devices 112, 114, 116 and also send advertisements to the user devices 106, 108, 110 for approval and acceptance.

C. Devices

FIG. 3 is a block diagram illustrating details of an example of the controller 102 of FIG. 1 (and/or the third-party server 118 of FIG. 2). The controller 102 is operative to manage the system and execute the methods of the present invention. The controller 102 may be implemented as one or more system controllers, one or more dedicated hardware circuits, one or more appropriately programmed general purpose computers, or any other similar electronic, mechanical, electromechanical, and/or human operated device. For example, in FIG. 2, the controller 102 is depicted as coupled to a third-party server 118. In the embodiment of FIG. 2, these two servers may provide the same functions as the controller 102 alone in the embodiment of FIG. 1.

The controller 102 (and/or the third-party server 118) may include a processor 300, such as one or more Intel® Pentium® processors. The processor 300 may include or be coupled to one or more clocks or timers (not pictured), which may be useful for determining information relating to, for example, whether an advertising opportunity deadline has occurred, and one or more communication ports 302 through which the processor 300 communicates with other devices such as the advertiser devices 112, 114, 116, the user devices 106, 108, 110 and/or the third-party server 118. The processor 300 is also in communication with a data storage device 304. The data storage device 304 may include any appropriate combination of magnetic, optical and/or semiconductor memory, and may include, for example, additional processors, communication ports, Random Access Memory (“RAM”), Read-Only Memory (“ROM”), a compact or DVD disc and/or a hard disk. The processor 300 and the storage device 304 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the controller 102 may comprise one or more computers (or processors 300) that are connected to a remote server computer operative to maintain databases, where the data storage device 304 is comprised of the combination of the remote server computer and the associated databases.

The data storage device 304 may store a program 306 for controlling the processor 300. The processor 300 may perform instructions of the program 306, and thereby operate in accordance with the present invention, and particularly in accordance with the methods described in detail herein. The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. The program 306 may be stored in a compressed, uncompiled and/or encrypted format. The program 306 furthermore may include program elements that may be generally useful, such as an operating system, a database management system and “device drivers” for allowing the processor 300 to interface with computer peripheral devices. Appropriate general purpose program elements are known to those skilled in the art, and need not be described in detail herein.

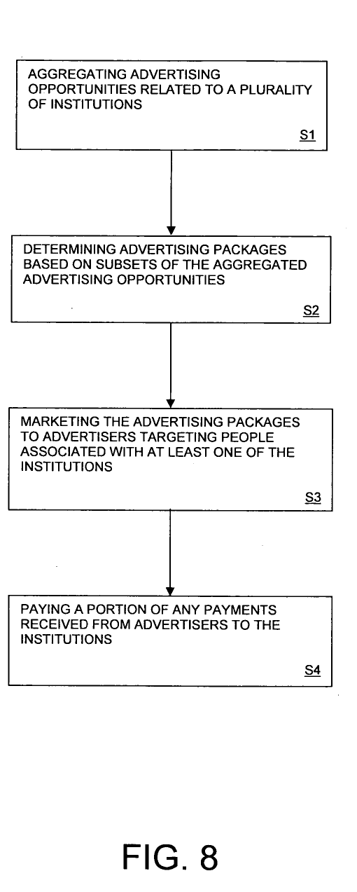

Further, the program 306 is operative to execute a number of invention-specific modules or subroutines including but not limited to one or more routines to allow an institution to describe an advertising opportunity via a user device 106, 108, 110; one or more routines to receive information about an advertising opportunity and/or an institution; one or more routines to receive an advertisement from an advertiser; one or more routines to determine if an institution accepts an advertisement; one or more routines to compute a rate for an advertising opportunity or a collection of advertising opportunities; one or more routines to present advertising opportunities to advertisers; one or more routines to charge advertisers for purchased advertising opportunities; one or more routines to facilitate and control communications between advertiser devices 112, 114, 116, user devices 106, 108, 110, the controller 102, and/or a third party server 118; and one or more routines to control databases or software objects that track information regarding users, advertisers, third parties, user devices 106, 108, 110, advertising opportunities inventory, promotions, events, institutions, and fulfillment. Examples of these routines and their operation are described in detail below in conjunction with the flowcharts depicted in FIGS. 8 through 10.

According to some embodiments of the present invention, the instructions of the program 306 may be read into a main memory (not pictured) of the processor 300 from another computer-readable medium, such from a ROM to a RAM. Execution of sequences of the instructions in the program 306 causes the processor 300 to perform the process steps described herein. In alternative embodiments, hard-wired circuitry or integrated circuits may be used in place of, or in combination with, software instructions for implementation of the processes of the present invention. In some embodiments, the methods of the present invention may be performed entirely by one or more humans communicating and/or interacting. Thus, embodiments of the present invention are not limited to any specific combination of hardware, firmware, and/or software.

In addition to the program 306, the storage device 304 is also operative to store (i) an advertising opportunities database 308, (ii) an advertising packages database 310; (iii) an institutions database 312, and (iii) an advertisers database 314. The databases 308, 310, 312, 314 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, the invention could be practiced effectively using one, two, three, five, six, or more functionally equivalent databases. Similarly, the illustrated entries of the databases represent exemplary information only; those skilled in the art will understand that the number and content of the entries can be different from those illustrated herein. Further, despite the depiction of the databases as tables, an object based model could be used to store and manipulate the data types of the present invention and likewise, object methods or behaviors can be used to implement the processes of the present invention. These processes are described below in detail with respect to FIGS. 8 through 10.

Although not pictured in detail, user devices 106, 108, 110 and advertiser devices 112, 114, 116 according to the present invention may each include a processor coupled to a communications port, a data storage device that stores an institution or advertiser program, and an I/O device. An institution program may include one or more routines to facilitate and control communications and interaction with the controller 102 as well as an interface to facilitate communications and interaction with an institution or the institution's computing system. Likewise, an advertiser program may include one or more routines to facilitate and control communications and interaction with the controller 102 as well as an interface to facilitate communications and interaction with an advertiser or an advertiser's computing systems. As indicated above, user devices 106, 108, 110 and advertiser devices 112, 114, 116 may be implemented by any number of devices such as, for example, a processor based cash register, a telephone, an IVR system, a cellular/wireless phone, a vending machine, a pager, a personal computer, a portable computer such as a laptop, a wearable computer, a palm-top computer, a hand-held computer, and/or a PDA.

D. Databases

As indicated above, it should be noted that although the example embodiment of FIG. 3 is illustrated to include four particular databases stored in storage device 304, other database arrangements may be used which would still be in keeping with the spirit and scope of the present invention. In other words, the present invention could be implemented using any number of different database files or data structures, as opposed to the four depicted in FIG. 3. Further, the individual database files could be stored on different servers (e.g. located on different storage devices in different geographic locations, such as on a third-party server 118). Likewise, the program 306 could also be located remotely from the storage device 304 and/or on another server. As indicated above, the program 306 includes instructions for retrieving, manipulating, and storing data in the databases 308, 310, 312, 314 as necessary to perform the methods of the invention as described below.

1. Advertising Opportunities Database

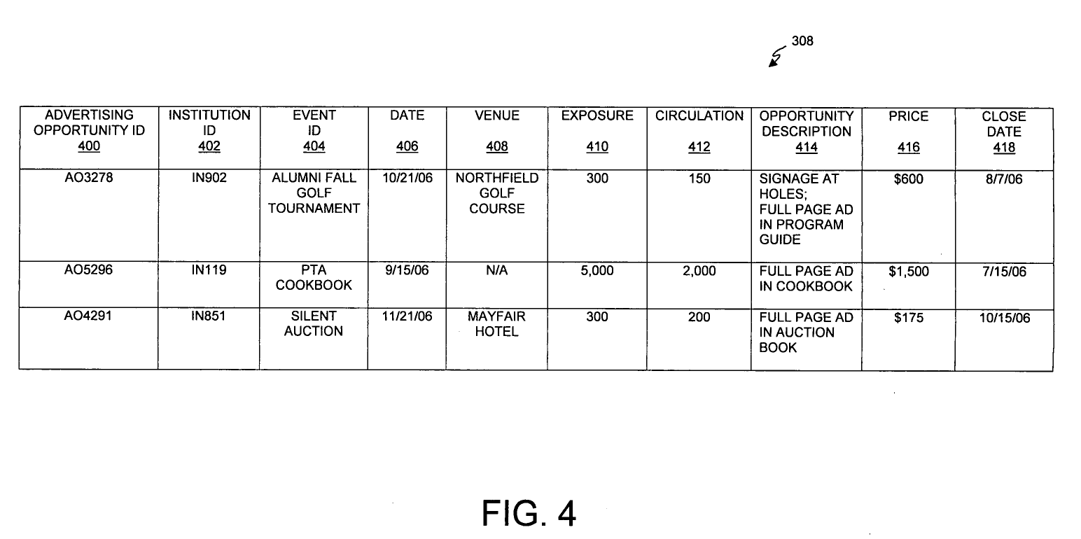

Turning to FIG. 4, a tabular representation of an embodiment of an advertising opportunities database 308 according to some embodiments of the present invention is illustrated. This particular tabular representation of an advertising opportunities database 308 includes three sample records or entries which each include information regarding a particular advertising opportunity. In some embodiments of the invention, an advertising opportunities database 308 is used to track information about particular advertising opportunities including the associated institution, any associated event(s), date of the event or publication, the venue (if there is an event), the amount of people who will be exposed to advertising, the circulation of any associated publication; a description of the advertising opportunity, price, and any deadlines associated with participating in the advertising opportunity. Those skilled in the art will understand that such an advertising opportunities database 308 may include any number of entries.

The particular tabular representation of an advertising opportunities database 308 depicted in FIG. 4 defines a number of fields for each of the entries or records. The fields may include: (i) an advertising opportunity identifier field 400 that may store a representation uniquely identifying the advertising opportunity; (ii) an institution identifier field 402 that may store a representation uniquely identifying one or more associated institutions; (iii) an event identifier field 404 that may store a representation uniquely identifying any associated events; (iv) a date field 406 that may store a representation of a date of any associated events or publications; (v) a venue field 408 that may store a representation indicating the location of any associated event; (vi) an exposure field 410 that may store a representation of the number of people expected to view the advertisement; (vii) a circulation field 412 that may store a representation of the number of copies of any associated publication that is to be distributed in conjunction with the advertising opportunity; (viii) an opportunity description field 414 that may store a representation descriptive of the advertising opportunity; (ix) a price field 416 that may store a representation of the price to participate in the advertising opportunity; and (x) a close date field 418 that may store a representation of a deadline to provide advertisements, information, and/or payment required to participate in the advertising opportunity.

The example advertising opportunity database 308 of FIG. 4 provides example data to illustrate the meaning of the information stored in this database embodiment. An advertising opportunity identifier 400 (e.g., AO3278, AO5296, AO42091) may be used to identify and index the different advertising opportunities listed in the advertising opportunity database 308. The records may include a institution identifier 402 (e.g., IN902, IN119, IN851) that may be specified to provide an index into the institutions database 312 discussed below. The records may each include one or more event identifiers 404 (e.g., Alumni Fall Golf Tournament, PTA Cookbook, Silent Auction) for any events associated with the advertising opportunity and the scheduled date 406 (e.g., Oct. 21, 2006, Sep. 15, 2006 Nov. 21, 2006 and venue 408 (e.g., Northfield Golf Course, N/A, Mayfair Hotel) of such events. The records may each include an anticipated exposure 410 count (e.g., 300, 5,000, 300) indicating the number of people expected to view any advertisement used to participate in the advertising opportunity. Likewise, the records may each include a circulation 412 count (e.g., 150, 2,000, 200) indicating the number of copies of any associated publication containing the advertisement that may be produced as an associated event or in conjunction with an associated event, if any. The records may each include an opportunity description 414 (e.g., Signage at Holes, Full Page Ad in Program Guide; Full Page Ad in Cookbook; Full Page Ad in Auction Book) that provides detailed information about the advertising opportunity or a reference to such information. The records may each include a close date 418 (e.g., Aug. 7, 2006, Jul. 15, 2006, Oct. 15, 2006) that indicates a last date to submit advertisements, information, and/or payment to institutions, advertising opportunity aggregator, and/or third-party service providers in order to be included in the advertising opportunity.

Finally, the records may each include price 416 (e.g., $600, $1,500 $175) information that indicates the price charged to include an advertisement or otherwise participate in the advertising opportunity. The value in the price field 416 may be determined based upon many different considerations such as, for example, the exposure 410; circulation 412; the type of publication; the likelihood people will keep the publication and view it repeatedly (i.e., a persistence factor); the potential goodwill an advertiser may earn from participating in an institution's fundraising efforts; the perceived generosity or community concern with which an advertiser may be credited from participation (i.e. a charity or support factor); the size, location, and type of advertisement; additional participation in “give-away” promotions; and the like.

2. Advertising Packages Database

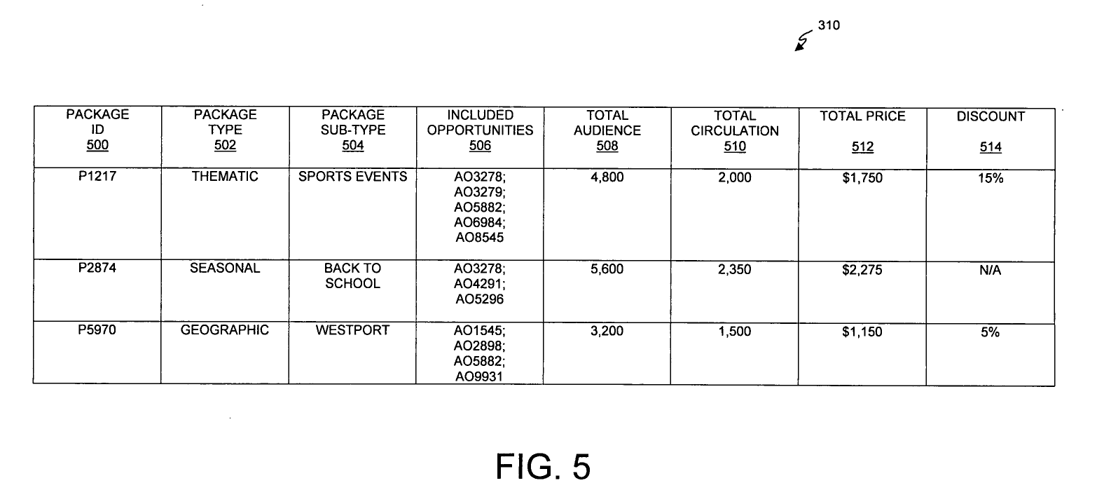

Turning to FIG. 5, a tabular representation of an embodiment of an advertising packages database 310 according to some embodiments of the present invention is illustrated. This particular tabular representation of an advertising packages database 310 includes three sample records or entries which each include information regarding a particular advertising package. In some embodiments of the invention, an advertising packages database 310 is used to track information about the advertising package including the type of advertising package, the advertising opportunities included, the total audience and circulation of all the associated advertising opportunities included, pricing information, and discounting information. Those skilled in the art will understand that such an advertising packages database 310 may include any number of entries.

The particular tabular representation of an advertising packages database 310 depicted in FIG. 5 defines a number of fields for each of the entries or records. The fields may include: (i) a package identifier field 500 that may store a representation uniquely identifying the package of advertising opportunities; (ii) a package type field 502 that may store a representation of a category into which all the advertising opportunities may be classified (e.g., thematic, seasonal, geographic, etc.); (iii) a package sub-type field 504 that may store a representation of the particular sub-category of the collection of advertising opportunities that make up the advertising package (e.g., for thematic: galas, cookbooks, or sports events; for seasonal: winter, back to school, or summer; for geographic: Northville, Hometown, or Westport; etc.); (iv) an included opportunities field 506 that may store a representation of all the advertising opportunities within which an advertiser will be entitled to participate if the advertising package is purchased; (v) a total audience field 508 that may store a representation of the total exposure expected for all the included advertising opportunities; (vi) a total circulation field 510 that may store a representation of the total number of publications to be distributed in conjunction with all the included advertising opportunities; (vii) total price field 512 that may store a representation of the price to be charged for the package; and (viii) a discount field 514 that may store a representation of a discount, if any, included in the price of the package.

The example advertising packages database 310 of FIG. 5 provides example data to illustrate the meaning of the information stored in this database embodiment. A package identifier 500 (e.g., P1217, P2874, P5970) may be used to identify and index the different advertisers listed in the advertising packages database 310. Together, the package type 502 (e.g., Thematic, Seasonal, Geographic) and the package sub-type 504 (e.g., Sports Events; Back to School; Westport) may be used to describe one or more characteristics in common among the included opportunities 506 (e.g., AO3278, AO3279, AO5882, AO6984, AO8545; AO3278, AO4291, AO5296; AO1545, AO2898, AO5882, AO9931). The total audience 508 (e.g., 4,800, 5,600, 3,200), the total circulation 510 (e.g., 2,000, 5,600, 3,200), and the total price 512 (e.g., $1,750, $2,275, $1,150) represents the sum of the exposure 410 counts, circulation 412 counts, and price 416, respectively, of the included opportunities 506. Finally, the discount 514 (e.g., 15%, N/A, 5%) is used to indicate an amount, if any, the total price 512 will be reduced to determine the price of the advertising package.

3. Institutions Database

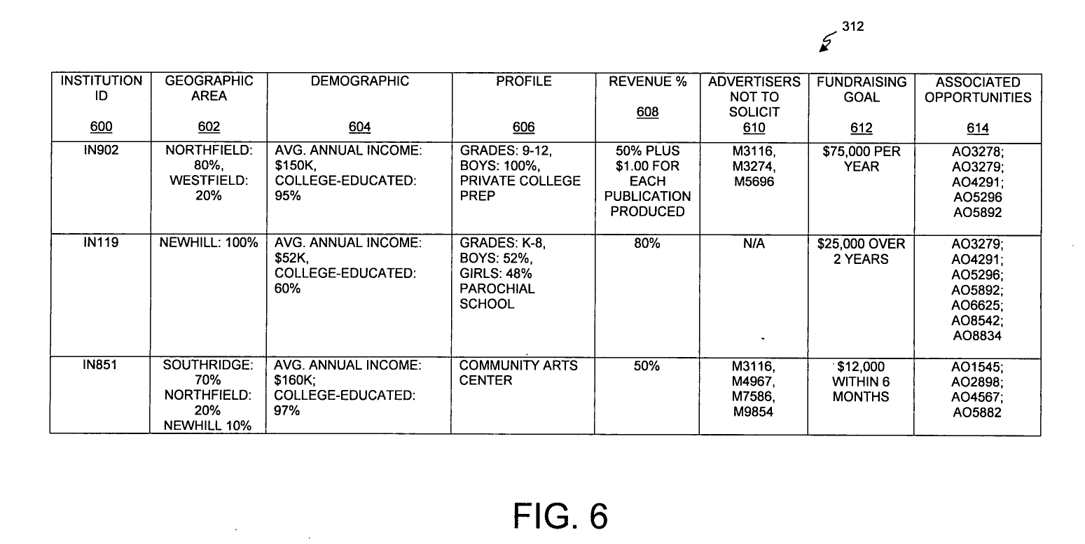

Turning to FIG. 6, a tabular representation of an embodiment of an institutions database 312 according to some embodiments of the present invention is illustrated. This particular tabular representation of an institutions database 312 includes three sample records or entries which each include information regarding a particular institution. In some embodiments of the invention, an institutions database 312 is used to track information about the institution including geographic, demographic, and profile information about people associated with the institution; revenue split information; advertisers with which the institution either already has agreements or does not want to transact and thus, are not to be solicited by an advertising opportunities aggregator; and fundraising goals of the institution. Those skilled in the art will understand that such an institutions database 312 may include any number of entries.

The particular tabular representation of an institutions database 312 depicted in FIG. 6 defines a number of fields for each of the entries or records. The fields may include: (i) an institution identifier field 600 that may store a representation uniquely identifying the institution; (ii) a geographic area field 602 that may store a representation of any geographic area related to the institution (e.g. the towns of residence of people associated with the institution); (iii) a demographic field 604 that may store a representation of one or more demographic characteristics (e.g., income level, education level, etc.) of people associated with the institution; (iv) a profile field 606 that may store a representation of one or more characteristics of the institution or people associated with the institution determined by the institution (e.g., the number of associated students, families, gender, religious affiliation, etc.); (v) a revenue percentage field 608 that may store a representation of the base percentage amount of the price 416 that the institution is to receive from an advertiser participating in advertising opportunities associated with the institution; (vi) an “advertisers not to be solicited” field 610 that may store a representation of a list specified by the institution of advertisers who are not to be approached by the advertising opportunities aggregator; and (vii) a fundraising goal field 612 that may store a representation of the total amount of funds the institution is attempting to raise via the contribution of advertising opportunities.

The example institutions database 312 of FIG. 6 provides example data to illustrate the meaning of the information stored in this database embodiment. An institution identifier 600 (e.g., IN902, IN119, IN851) may be used to identify and index the different institutions listed in the institutions database 312. The geographic area 602 (e.g., Northfield 80%, Westfield 20%; Newhill 100%, Southridge 70%, Northfield 20%, Newhill 10%) may be used to indicate the towns, cities, counties, regions, and/or other areas of people associated with the institution that would likely receive advertisements as a result of participation in the advertising opportunities related to the institution. The demographic 604 (e.g., Avg. Annual Income: $150 K, College-educated: 95%; Avg. Annual Income: $52 K, College-educated: 60%; Avg. Annual Income: $160 K, College-educated: 97%) may be used to indicate characteristics of people associated with the institution that would likely receive advertisements as a result of participation in the advertising opportunities related to the institution. The profile 606 (e.g., Grades: 9-12, Boys: 100%, Private College Prep; Grades: K-8, Boys: 52%, Girls: 48%, Parochial Elementary School; Community Arts Center) may be used to indicate characteristics of the institution and people associated with the institution that are specified by the institution. The revenue percentage 608 (e.g., 50% plus $1.00 for each publication produced; 80%; 50%) may be used to indicate the amount the institution is to receive for including advertisements in events (and/or publications) of the institutions. The amount may be determined between the institution and the advertising opportunities aggregator. The amount may be specified as a percentage of the price 416 of an advertising opportunity, as a fixed amount, and/or as a variable amount based on many factors such as, for example, the type of advertisements, the type of publications, the level of involvement of the advertising opportunities aggregator, the contribution of any promotional prizes or gifts by the advertisers, any gifts given to the advertisers or aggregator by the institution, and the like. The list of advertisers not to be solicited 610 (e.g., M3116, M3274, M5696; N/A; M3116, M4967, M7586) allows the institution to specify to the advertising opportunities aggregator certain advertisers or types of advertisers that the institution does not want the aggregator to contact. In some cases it may be that the institution does not want to permit the listed advertisers to participate. In some cases it may be that the institution may have a prior relationship with the listed advertisers. The fundraising goal 612 (e.g., $75,000 per year, $25,000 over 2 years, $12,000 within 6 months) is used to indicate an amount the institution is trying to raise within a given time frame. Such information may help the advertising opportunities aggregator determine pricing information, suggest events the institution may employ, and/or the quantity and quality of advertising opportunities that would be required to achieve the institution's goal. Finally, the associated opportunities 614 (e.g., AO3278, AO3279, AO4291, AO5296, AO5892; AO3279, AO4291, AO5296, AO5892, AO6625, AO8542, AO8834; AO1545, AO2898, AO4567, AO5882) include a list of the advertising opportunities associated with the institution.

4. Advertisers Database

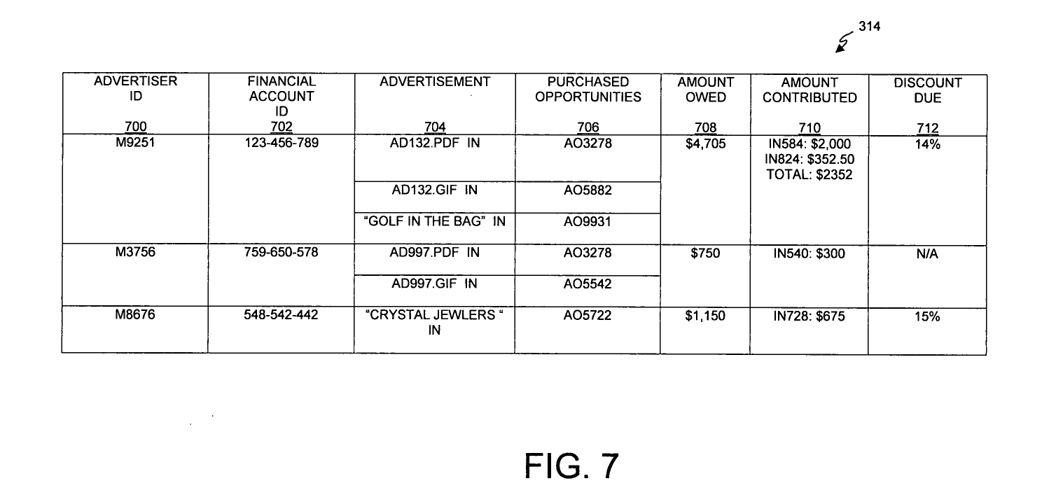

Turning to FIG. 7, a tabular representation of an embodiment of an advertisers database 314 according to some embodiments of the present invention is illustrated. This particular tabular representation of an advertisers database 314 includes three sample records or entries which each include information regarding a particular advertiser. In some embodiments of the invention, an advertisers database 314 is used to track information about the advertiser including financial account information, advertisements, purchased advertising opportunities, and the amount the advertiser owes for purchased advertising opportunities. Those skilled in the art will understand that such an advertisers database 314 may include any number of entries.

The particular tabular representation of an advertisers database 314 depicted in FIG. 7 defines a number of fields for each of the entries or records. The fields may include: (i) an advertiser identifier field 700 that may store a representation uniquely identifying the advertiser; (ii) a financial account identifier field 702 that may store a representation of a bank, credit card, or other financial account number for charging the advertiser for purchased advertising opportunities; (iii) an advertisement field 704 that may store a representation of one or more advertisements; (iv) a purchased advertising opportunities field 706 that may store a representation of a list of advertising opportunities (by advertising opportunity identifier) that the advertiser has purchased; (v) an amount owed field 708 that may store a representation of the amount the advertiser owes for purchased advertising opportunities; (vi) an amount contributed field 710 that may store a representation of the amount the advertiser has contributed to institutions; and (vii) a discount due field 712 that may store a representation of a discount percentage the particular advertiser is entitled to based upon the number of advertising opportunities purchased and/or other factors.

The example advertisers database 314 of FIG. 7 provides example data to illustrate the meaning of the information stored in this database embodiment. An advertiser identifier 700 (e.g., M9251, M3756, M8676) may be used to identify and index the different advertisers listed in the advertisers database 314. In some embodiments, actual advertisers' names may be used. The records may include a financial account identifier 702 (represented by an account number, e.g., 123-456-789, 759-650-578, 548-542-442) that may be specified to facilitate billing or actually charging advertisers for services rendered, i.e. publishing advertisements. The records may each include one ore more actual advertisements, ad copy, or advertisement identifiers 704 that the advertiser wants to be used for particular purchased advertising opportunities specified in an associated purchased advertising opportunities field 706 (e.g., AD132.PDF in AO3278, AD132.GIF in AO5882, “Golf in the Bag” in AO9931; AD997.PDF in AO3278, AD997.GIF in AO8842; “Crystal Jewelers” in AO5722). The records may store accounting information such as amounts owed by the advertisers (e.g., $4,705, $750, $1,150) for services rendered (or to be rendered) to the advertisers as well as amounts the advertisers' advertisement purchases have benefited the institutions (e.g. IN584 has received $2,000, IN824 has received $352.50; IN540 has received $300; IN728 has received $675). Finally the records may indicate a percentage discount for which the advertisers have qualified (e.g. 14%, N/A, 15%).

E. Methods

The system discussed above, including the hardware components and the databases, are useful to perform the methods of the invention. However, it should be understood that not all of the above described components and databases are necessary to perform any of the present invention's methods. In fact, in some embodiments, none of the above described system is required to practice the invention's methods. The system described above is an example of a system that would be useful in practicing the invention's methods. For example, the advertisers database 314 described above is useful for tracking advertisers and information about them, but it is not absolutely necessary to have such a database in order to perform the methods of the invention. In other words, the methods described below may be practiced using a conventional customer list in conjunction with a transaction log.

Referring to FIGS. 8 through 10, flow charts are depicted that represents some embodiments of the present invention that may be performed by the controller 102 (FIGS. 1 and 2), an external third party, and/or an integrated third party entity/device such as a third-party server 118. It must be understood that the particular arrangement of elements in the flow charts of FIGS. 8 through 10, as well as the order of example steps of various methods discussed herein, is not meant to imply a fixed order, sequence, and/or timing to the steps; embodiments of the present invention can be practiced in any order, sequence, and/or timing that is practicable.

In general terms and referring to FIG. 8, the method of some embodiments of the present invention may be summarized as follows. In Step S1, advertising opportunities are aggregated. In Step S2, advertising packages are determined. In Step S3, the advertising packages are marketed to advertisers. In Step S4, the institutions providing the advertising opportunities are paid a share of advertising revenues received.

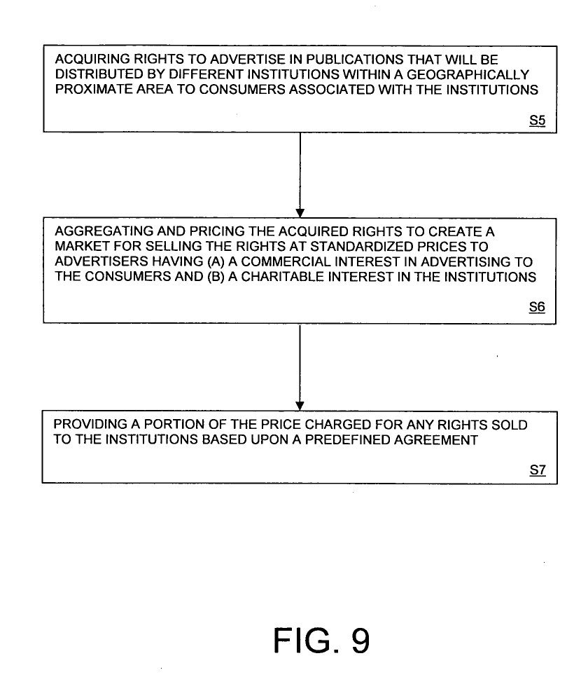

In general terms and referring to FIG. 9, a second example method of some embodiments of the present invention may be summarized as follows. In Step S5, rights to advertise in publications that will be distributed by different institutions within a geographically proximate area to consumers associated with the institutions are acquired. In Step S6, the acquired rights are aggregated and priced to create a market for selling the rights at standardized prices to advertisers having a commercial interest in advertising to the consumers and a charitable interest in the institutions. In Step S7, a portion of the price charged for any rights sold is provided to the institutions based upon a predefined agreement.

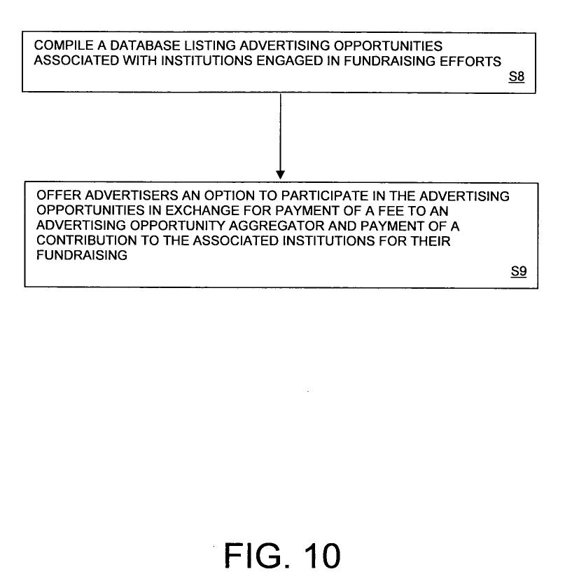

In general terms and referring to FIG. 10, a third example method of some embodiments of the present invention may be summarized as follows. In Step S8, a database listing advertising opportunities associated with institutions engaged in fundraising efforts is compiled. In Step S9, advertisers are offered an option to participate in the advertising opportunities in exchange for payment of the fee to an advertising opportunity aggregator and payment of a contribution to the associated institutions' fundraising efforts.

In the subsections that follow, each of the above steps will now be discussed in greater detail. Note that not all of these steps are required to perform the methods of the present invention and that additional and/or alternative steps are also discussed below. Also note that the above general steps represent features of only some of the embodiments of the present invention and that they may be combined and/or subdivided in any number of different ways so that the methods includes more or less actual steps. For example, in some embodiments many additional steps may be added to update and maintain the databases described above, but as indicated, it is not necessary to use the above described databases in all embodiments of the invention. In other words, the methods of the present invention may contain any number of steps that are practicable to implement the processes described herein. The methods of the present invention are now discussed in detail.

Referring to FIG. 8, a first example embodiment of a method according to the present invention may be described in four general steps:

1. Aggregate Advertising Opportunities

In Step S1, a plurality of disparate advertising opportunities related to future events are aggregated together. In some embodiments, an advertising opportunities aggregator contacts a large number of institutions that sponsor, host, organize, and/or run events. The institutions may include, for example, private schools, community center organizations, arts organizations, churches, and the like. In some embodiments, the institutions to be contacted are selected based upon factors related to characteristics of the people associated or involved with the institutions. For example, an aggregator may choose to contact a particular private school because it is known that the families of the school's students are affluent, college educated, homeowners from a high cost of living geographic area.

In some embodiments, future events may include, for example, such things as publication of a yearbook, a sports tournament, a homecoming parade, a show, a dance, a community party, and the like. Events may have one or more publications associated with them. For example, a show may have a playbill, a sports tournament may have a program, a community party may have a website. Each such publication may represent one or more advertising opportunities. For example, half page advertisements on different pages, a congratulatory message on page one, a full page advertisement on the back cover, an animated banner advertisement on a homepage, and the like. In addition, the events themselves may provide many different advertising opportunities such as signage at a baseball game, an automobile raffle at a show, favors at a community center party, and the like. In some embodiments, future events are each sponsored, hosted, run, organized, and/or otherwise associated with an institution.

In some embodiments, the advertising opportunities aggregator establishes a contractual relationship with the institutions. In some embodiments, the institutions may commit to allowing their advertising opportunities to be sold to advertisers. The institutions may provide information about people affiliated with the institution or likely to participate in the events so that the associated advertising opportunities may be characterized and valued for advertisers. Note that individual advertising opportunities may have little or no significant value but that collectively, an aggregation of advertising opportunities may represent a commercially viable “media buy.”

In some embodiments, the advertising opportunities aggregator may employ an automated system to allow institutions (or groups associated with the institutions) to “sign-up” to list individual advertising opportunities via the Internet 104. In such embodiments, a website running on a controller 102 (or a third-party server 116) may ask (via an online questionnaire) an institution to provide the type of information contained in the example advertising opportunity database 308 of FIG. 4 and the example institution database 312 of FIG. 6. The institutions may communicate with the controller via a user device 106. In some embodiments, once the institution lists its information, the aggregator may contact the institution to negotiate revenue percentage 608 and work out other details. For example, the aggregator may help the institution determine a price 416 at which to price individual advertising opportunities so that they are both proportional to the opportunities' value and competitive with other opportunities.

2. Determine the Advertising Packages

In Step S2, a plurality of advertising packages based on subsets of the aggregated plurality of disparate advertising opportunities are determined. The advertising packages may each include a standardized package price and a set of one or more included advertising opportunities. The standardized package price may be determined based upon a market value of the included advertising opportunities and upon a goodwill value that advertisers may gain from supporting the institutions associated with a purchased advertising package. As indicated above, the price of a package may reflect a synergistic effect from aggregating a number of advertising opportunities. For example, a particular merchant may want to be perceived as being supportive of education in a particular town. Such an advertiser may purchase a package of advertising opportunities related to every fundraising event held in that town by any school during the early fall “back to school” time period. Advertisers may view advertising packages as a cost effective means to purchase effective targeted advertising and, at the sometime, express support for the institutions and people affiliated with the institutions.

In some embodiments, advertising opportunities may be packaged based upon any number of different factors. For example, packages may be determined based upon categories such as, for example, themes associated with associated events, the seasons in which associated events occur, the geographic distribution of people who will be exposed to the advertisements, and the like. Within the categories, the advertising opportunities may be packaged based upon sub-categories. For example, within the thematic category, advertising opportunities may be packaged as sports related, arts related, social events, publications, etc. The particular subsets of advertising opportunities selected to form a package may be based upon the requirements of a particular advertiser. For example, if a merchant who sells automobiles would like to display a new luxury car to people who typically purchase luxury cars, a package may be assembled based upon exclusive gala events that will include valet parking.

In some embodiments, packages may be assembled to help achieve advertising campaign objectives. For example, a package may be designed to target people with disposable income to spending on extensive home remodeling or the arts. In some embodiments, advertisers may select sets of advertising opportunities based upon, for example, popularity among other advertisers, an advertiser's own preferences, the choices of other advertisers, and the like. In some embodiments, a program 306 may automatically group similar advertising opportunities into a package based upon the manner in which an institution described the opportunity, an associated event, the institution, and/or the people affiliated with the institution. Note that advertising opportunities may each be part of more than one package.

3. Market the Advertising Packages

In Step S3, the advertising packages are marketed to a plurality of advertisers who seek to target people associated with at least one of the plurality of institutions. In some embodiments, potential advertisers identified by the intuitions (e.g., in the “advertisers not to solicit” field 610 of an institutions database 312 of FIG. 6) may be excluded from the marketing efforts.

In some embodiments, as advertisers are presented with and sold advertising packages and/or participation in one or more advertising opportunities, a record of the transactions for each advertiser may be stored, for example, in an entry of an advertisers database 314 of FIG. 7. In some embodiments that are automated or partially automated, a program 306 may direct a controller 102 to store data regarding advertisers in an advertisers database 314 as advertisers commit to purchasing advertising opportunities. In some embodiments, advertisers may access a website on the controller 102 (or third-party server 116) via any number of advertiser devices 112, 114, 116, that may present a selection of advertising packages and/or individual advertising opportunities for consideration by the advertisers. In some embodiments, the presentation may be customized based upon requirements or other information provided by the advertiser. For example, the website may ask (via a questionnaire) advertisers to indicate the number of people they wish to reach, the desired timeframe, the desired demographics, the desired advertisement, whether there are any institutions that the advertisers wish to support, etc. The program 306 may take this information and determine advertising packages that suit the advertiser's specific requirements or information.

4. Pay the Institutions

In Step S4, a portion of any standardized package price payments received from advertisers are paid to the institutions based upon a fee agreement. In some embodiments, such a payment will be in the form of a contribution to the institutions independent from a fee paid to the aggregator. In some automated embodiments, the fees may be charged via the program 306 using financial account 702 information provided by the advertiser.

Referring to FIG. 9, a second example embodiment of a method according to the present invention may be described in three general steps (numbered S5 through S7):

1. Acquire Rights from Institutions

In Step S5, an advertising rights aggregator acquires rights, at no initial monetary cost, to advertise in a plurality of publications. These rights may be acquired from various institutions. In some embodiments, the institutions may retain the right to approve or reject a particular advertiser, advertisement, and/or type of advertiser or advertisement. In some embodiments, the aggregator may purchase an option for rights to advertise in a plurality of publications. In some embodiments, the publications may be disparate and non-commercial. In some embodiments, the publications will be produced and/or distributed by the institutions and/or their agents. In some embodiments, the institutions are disparate and/or non-profit. In some embodiments, the institutions are within a geographically proximate distance to consumers associated with at least one of the institutions.

2. Aggregate and Price Rights to Create a Market

In Step S6, a market for buying and selling the acquired advertising rights is created. In some embodiments, the acquired advertising rights are aggregated into commercially marketable advertising packages. The individual rights and advertising packages are priced based upon a standardized method. The standardized method may include determining pricing based upon a fair market value of the rights and/or advertising packages relative to conventional advertising opportunities. For example, in some embodiments, pricing may be based upon the amount of exposure provided by each of the rights and/or advertising packages. In some embodiments, the standardized method may include describing the rights and/or advertising packages in a standardized manner and allowing multiple advertisers to bid on the rights and/or advertising packages following a closely adhered to procedure. In some embodiments, the market for buying and selling the advertising rights may be in the form of an online system hosted by a controller 102 (or third-party server 116) that facilitates competitive bidding and/or negotiation for the rights by advertisers via advertiser devices 112, 114, 116. In some embodiments, the rights may offered to advertisers having a commercial interest in advertising to the consumers (associated with at least one of the associated institutions) and/or a charitable interest in the associated institutions.

3. Compensate the Institutions

In Step S7, a portion of the price charged for any rights sold is provided to the associated institutions respectively. The amount paid to the institutions may be based upon a predefined agreement between the institutions and the advertising rights aggregator. In some embodiments, the agreement may between several institutions and an aggregator. In some embodiments, many different agreements may be employed to each define a relationship between individual institutions and the aggregator.

Referring to FIG. 10, a third example embodiment of a method according to the present invention may be described in two general steps (numbered S8 and S9):

1. Compile a Database of Advertising Opportunities

In Step S8, a database listing a plurality of advertising opportunities is complied. For example, the format suggested by the example advertising opportunities database 308 depicted in FIG. 4 may be employed. In some embodiments, each advertising opportunity is associated with at least one of a plurality of institutions. The institutions may be for example, private schools or other organizations. In some embodiments, each advertising opportunity specifies an associated fee required to purchase the advertising opportunity. In some embodiments, each of the institutions is engaged in at least one fundraising effort.

2. Offer Advertisers an Option to Participate

In Step S9, a plurality of advertisers are offered an option to participate in the advertising opportunities. In some embodiments, the offer is in exchange for payment of the fee to an advertising opportunity aggregator and the payment of a contribution to the associated institutions toward the institutions' fundraising efforts. In some embodiments, the contribution may be determined by the advertising opportunity aggregator and/or paid through the advertising opportunity aggregator.

### F. EXAMPLE

The following very specific example is provided to illustrate particular embodiments of the present invention, particularly from the perspective of potential users of the invention, such as advertisers and institutions.

The Junior Class of Hometown Academy in Hometown, Calif. publishes a cookbook each year to raise funds for a class gift. Most of the funds raised come from sales of the cookbook to student families. The local copy center usually prints the cookbook at a discounted rate in exchange for being allowed to include an advertisement at the end of the book. Typically the amount raised is just a few hundred dollars which is used to purchase and plant a tree or some other relatively modest gift.

This year however, the Junior Class has decided to purchase an expensive collection of books to significantly expand the library's collection. The cost of this gift is approximately $20,000. The publishing committee puts into action an ambitious plan to sell advertising space in the cookbook. After many failed attempts however, the volunteers on the publishing committee determine that local merchants and other potential advertisers are not interested or cannot justify the unbudgeted expense for a single advertisement in the cookbook.

Fortunately, one member of the publishing committee has been contacted by an advertising opportunities aggregator who is able to include the Hometown Academy Cookbook into a “school publications” advertising package that is very well subscribed to by many regional and national advertisers seeking advertising access to the types of families with children attending an institution like Hometown Academy. The advertising opportunities aggregator explains that the publishing committee may receive $500 dollars for each of forty advertisements if they can sell 1000 copies of the cookbook. Although selling 1000 copies is more than any class has previously sold, the committee is confident they can reach this goal because they can charge a much reduced price for each copy of the cookbook since most of the fundraising will be realized from the advertising contribution.

### G. Additional Embodiments of the Invention

The foregoing description discloses only exemplary embodiments of the invention. Modifications of the above disclosed apparatus and methods which fall within the scope of the invention will be readily apparent to those of ordinary skill in the art. The following are example alternative variations which illustrate additional embodiments of the present invention. It should be understood that the particular variations described in this section may be combined with the different embodiments, or portions thereof, described above in any manner that is practicable. These examples do not constitute a definition or itemization of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

The present invention may include the additional step of allowing advertisers to know what their contribution to the institutions helps fund. In some embodiments, advertisers may be permitted to specify the fundraising effort to which their contribution is directed.

In some embodiments, advertisers may be permitted to bid for advertising opportunities that are in high demand. In some embodiments, the advertising opportunities may be sold on a first-come-first-served basis. In some embodiments, the institutions may determine a priority for advertiser's participation in advertising opportunities.

In some embodiments, the price of advertising opportunities may be determined based upon how likely the associated publication is to be treated as a keepsake item. A “persistence factor” reflecting this aspect of advertising value may be considered in calculating the price of the associated advertising opportunities. Likewise, in some embodiments, the price of advertising opportunities may be determined based upon other emotional factors that may effect the significance a viewer of the advertisement may ascribe to the fact that an advertiser invested or supported an institution and/or a community. A “goodwill factor” reflecting this aspect of advertising value may be considered in calculating the price of the associated advertising opportunities.

### H. CONCLUSION

It is clear from the foregoing discussion that the disclosed systems and methods for marketing community-oriented advertising opportunities represents an improvement in the arts of electronic commerce, fundraising, and advertising. While the methods and apparatus of the present invention has been described in terms of presently preferred and alternate exemplary embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, enhancements, and other embodiments are possible without departing from the teachings thereof. All such modifications are intended to be encompassed within the following claims.

What is claimed is:

1. A method comprising:
compiling a database listing a plurality of future events, each future event to be sponsored by one or more non-profit institutions and having at least one associated advertising opportunity and an associated participation fee;
determining a plurality of advertisers; and
offering at least one of the advertisers an option to participate in the advertising opportunities in exchange for the participation fee,
wherein the participation fee includes a contribution portion for the non-profit institution sponsoring the future event and an advertising fee portion for an advertising opportunity aggregator.

2. The method of claim 1 wherein the future events include annual events and the database includes entries for a same annual event to be held in successive years.

3. The method of claim 1 wherein compiling a database includes establishing agreements between each of a plurality of non-profit institutions and the advertising opportunity aggregator wherein the non-profit institutions each commit to generating a publication associated with the sponsored future event wherein the publication includes advertising space reserved for the advertising opportunity aggregator.

4. The method of claim 3 wherein the advertising opportunity aggregator commits to not solicit advertisers identified by the non-profit institutions.

5. The method of claim 1 wherein the non-profit institutions include private schools serving families within a target market of the advertisers.

6. The method of claim 1 wherein the non-profit institutions include private schools that include people associated therewith that have demographic characteristics relevant to the advertisers.

7. The method of claim 1 wherein the future events include at least one of a distribution of a publication, an auction, a tournament, a social activity, and a school event.

8. The method of claim 1 wherein the at least one associated advertising opportunity includes advertising space in one or more publications generated in association with each of the future events.

9. The method of claim 8 wherein the publications include keepsake publications.

10. The method of claim 1 wherein determining a plurality of advertisers includes identifying merchants having a benefactor interest in at least one of the non-profit institutions and a marketing interest in people associated with at least one of the non-profit institutions.

11. The method of claim 1 wherein the advertisers provide a message to be published to a target market.

12. The method of claim 11 wherein the message includes a non-commercial message.

13. The method of claim 1 further including determining the advertising fee portion of the participation fee based upon a value of the associated advertising opportunity and determining the contribution portion of the participation fee based upon potential to gain goodwill of people affiliated with the non-profit institutions.

14. A method comprising:
determining a plurality of publications each associated with at least one of a plurality of private educational institutions;
determining a participation fee and a contribution amount associated with each of the plurality of publications;
determining a plurality of merchants that serve families associated with at least one of the plurality of private educational institutions, each merchant having at least one associated commercial message; and
offering each merchant an opportunity to include the associated commercial messages in a plurality of the publications in exchange for the associated participation fees to be paid to a service provider and the contribution amounts to be paid to the private educational institutions associated with the publications.

15. A method comprising:
acquiring rights, at no initial monetary cost, to advertise in a plurality of disparate non-commercial future publications that will be distributed by disparate non-profit institutions within a geographically proximate area to consumers associated with at least one of the non-profit institutions;
aggregating and pricing the acquired rights to create a market for selling the rights at standardized prices to advertisers having at least one of a commercial interest in advertising to the consumers and a charitable interest in the non-profit institutions; and
providing a portion of a price charged for any rights sold, to the non-profit institutions based upon a predefined agreement.

16. A method comprising:
aggregating a plurality of disparate advertising opportunities related to a plurality of future events, each future event to be organized by at least one of a plurality of private educational institutions;
determining a plurality of advertising packages based on subsets of the aggregated plurality of disparate advertising opportunities,
wherein the advertising packages each include a standardized package price and a set of associated advertising opportunities, and
wherein the standardized package price is determined based upon a market value of the set of associated advertising opportunities and upon a goodwill value of a potential benefactor relationship with the private educational institutions associated with a particular advertising package;
marketing the advertising packages to a plurality of advertisers who seek to target members of families associated with at least one of the plurality of private educational institutions; and
paying a portion of any standardized package price payments received from advertisers to the private educational institutions based upon a fee agreement.

17. The method of claim 16 further comprising:
compiling a database listing the plurality of future events, each future event to be hosted by at least one of the plurality of private educational institutions and each future event including at least one associated advertising opportunity and an associated fee; and
offering the plurality of advertisers, each having at least one advertising need, an option to participate in the advertising opportunities based upon the at least one advertising need in exchange for payment of the fee to an advertising opportunity aggregator and payment of a contribution to the private educational institution hosting the future event.

18. The method of claim 17 further comprising:
determining advertising values of each of the plurality of future events,
wherein determining a plurality of advertising packages includes determining one or more advertising opportunities related to each of the future events and determining an aggregation of the advertising opportunities that represents a media buy opportunity that is more valuable than a sum of values of the individual advertising opportunities due to a synergistic effect of the aggregation, and
wherein offering an option to participate includes offering the media buy opportunity at a price determined based upon the value of the sum of values of the individual advertising opportunities and a value of a benefactor relationship with the educational institutions.

19. The method of claim 16 wherein the plurality of private educational institutions serve a geographic area associated with an advertising target of the plurality of advertisers.

20. The method of claim 16 wherein the plurality of private educational institutions serve a community associated with an advertising target of the plurality of advertisers
